(19) United States
(12) Patent Application Publication
(10) Pub. No.: US 2017/0108272 A1
(43) Pub. Date: Apr. 20, 2017

(54) METHOD FOR DRYING FOOD, DRYING DEVICE, AND FOOD

(71) Applicant: TAKAHATA ELECTRONICS CORPORATION, Yonezawa-shi, Yamagata (JP)

(72) Inventors: Ichiro KANO, Yonezawa-shi, Yamagata (JP); Junji KIDO, Yonezawa-shi, Yamagata (JP)

(21) Appl. No.: 15/308,780

(22) PCT Filed: Aug. 5, 2015
(86) PCT No.: PCT/JP2015/072183

§ 371 Date: Nov. 7, 2016

(30) Foreign Application Priority Data
Aug. 8, 2014 (JP) 2014-162454

(51) Int. Cl. F26B 21/10; F26B 21/04; F26B 9/06; A23L 3/40; F26B 3/04

(52) U.S. Cl. CPC F26B 21/10; A23L 3/40; F26B 3/04; F26B 9/06; F26B 21/04; A23V 2002/00

(57) ABSTRACT

Provided is a simple method for drying food and a drying device that can maintain color, scent, and flavor of the food without deteriorating original nutrition value of the food and prevent deterioration of the food due to reproduction of bacteria and food produced by such a method and a device with respect to agricultural product such as grains, beans, potatoes, vegetables, mountain vegetables, mushrooms, nuts, fruits, and herbs or marine product such as seaweeds and seafood. Food of agricultural product or marine product is placed in a dry warehouse for drying the food, upper gas and lower gas in the dry warehouse are circulated by a duct fan provided to the side in the dry warehouse, and the food is dehumidified and dried under the atmospheric pressure and at the temperature of 60° C. or lower and the relative humidity of 60% or less to obtain dried food.

### TECHNICAL FIELD

The present invention relates to a method for drying food and a drying device for drying fresh food such as fruit and vegetable while preventing oxidation and preventing loss of fresh ingredient as much as possible, and to food produced with such method or device.

### BACKGROUND ART

Food has been conventionally dried for the purpose of improving transportability by reduction in weight or enabling long-term storage by preventing reproduction of microorganism by removing moisture contained in the food.

Various methods for drying food are known, which includes sun drying, drying with microwave, far-infrared ray, or hot air for high-temperature heating, reduced-pressure (vacuum) dry, and freeze dry, for example.

However, since sun drying depends on the weather, it is difficult to produce dry food with constant quality.

In addition, in drying under high-temperature heating, destruction of vitamin and protein contained in food and heat denaturation occur and only the surface of the food is rapidly dried and hardened which results in uneven drying. Therefore, there has been a problem of not only large loss of nutrition value but also loss of color, scent, and flavor.

On the other hand, reduced-pressure (vacuum) dry requires sealing property in equipment and equipment used therefor is expensive. In addition, although freeze dry can prevent reduction of nutrition value due to high-temperature heating as described above, equipment is expansive and operating cost of the equipment is also expensive. Moreover, there has been a problem of loss of scent and flavor due to destruction of cell tissue by freezing.

To deal with those problems, a method using desiccating agent, a method in which air with about 30 to 50° C. is circulated, a method in which air is always taken and discharged from/to outside, and a technique for efficiently drying with random airflow with 40° C. or lower are disclosed as a method for drying with normal temperature (constant temperature) while preventing unevenness of the temperature and the humidity, for example (For example, see Patent Literature 1 and 2).

### CITATION LIST

### Patent Literature

Patent Literature 1: JP-A-9-75048

Patent Literature 2: JP-B-4448008

### SUMMARY OF INVENTION

### Technical Problem

In normal temperature drying as described above, there is less deterioration of ingredient and change in color since it does not use high-temperature heating, and cost is not expensive. However, since it requires five hours or more at the normal temperature, which is a long time, bacteria are reproduced in some cases when food is not sufficiently sterilized before drying. In addition, it has not been possible to prevent change in color of pulp for white peach or apple that is easily oxidized, and it has not been possible to say that quality is assured as dry fruit.

The present invention has been developed to solve the above technical problems, and an object of the present invention is to provide a simple method for drying food and a drying device that can maintain color, scent, and flavor and prevent deterioration of food due to reproduction of bacteria without losing original nutrition value of the food and food produced with such a method or a device.

### Solution to Problem

A method for drying food according to the present invention includes dehumidifying and drying food of an agricultural product or a marine product placed in a dry warehouse for containing and drying the food under an atmospheric pressure and at a temperature of 60° C. or lower and a relative humidity of 60% or less by circulating upper gas and lower gas in the dry warehouse by a duct fan provided to a side inside the dry warehouse.

According to drying under the atmosphere at the normal temperature or the low temperature, food can be dried while preventing change of original nutrition value, color, scent, and flavor of the food and preventing deterioration of the food due to reproduction of bacteria.

In the method for drying described above, it is preferable that the duct fan be provided so that air is taken at an upper part in the dry warehouse and supplied in a horizontal direction at a lower part in the dry warehouse or air is taken at a lower part in the dry warehouse and supplied in a horizontal direction at an upper part in the dry warehouse.

By circulating gas in the dry warehouse as described, the temperature and the humidity in the upper part and the lower part of the dry warehouse tend to become even, and it is possible to dry food evenly and in a short time.

In addition, it is preferable that random wind be generated in the horizontal direction in the dry warehouse.

With such air blow, the temperature and the humidity in the horizontal direction in the dry warehouse tend to become even, and it is possible to dry food evenly and in a shorter time.

In the method for drying described above, it is preferable that the oxygen concentration in the dry warehouse be 10% or less in terms of prevention of oxidation.

Alternatively, it is preferable to provide gas with the oxygen concentration of 10% or less in the dry warehouse.

More preferably, gas with the humidity lower than outer air is supplied.

As gas to be supplied in the dry warehouse, nitrogen with the purity of 90% or more is preferably used as inert gas.

In addition, a food drying device according to the present invention is a drying device used for the method for drying described above, wherein a dehumidifier for dehumidifying gas in the dry warehouse is provided inside the dry warehouse or outside the dry warehouse, and a duct fan is provided to a side inside the dry warehouse.

It is preferable that the duct fan have an inlet or an outlet at an upper part or a lower part in the dry warehouse, and a fan be provided at the central part or the outlet of a duct.

With such a duct fan, it becomes easy to carry out control for efficiently circulating gas in the dry warehouse.

In addition, it is preferable that a food drying device according to the present invention have several fans for generating random wind in the horizontal direction in the dry warehouse on the side inside the dry warehouse in order to equalize the temperature and the humidity in the horizontal direction in the dry warehouse.

Furthermore, it is preferable that a nitrogen generation unit for generating nitrogen with a purity of 90% or more to be supplied in the dry warehouse be provided.

In addition, according to the present invention, food produced by the method for drying described above is provided.

### Advantageous Effects of Invention

According to a method for drying food and a drying device according to the present invention, food can be dried while preventing loss of original nutrition value of the food, maintaining color, scent, and flavor, and preventing deterioration of the food due to reproduction of bacteria.

Therefore, according to the present invention, it is possible to provide dry food with better quality than normal temperature dry food that has been conventionally provided.

### BRIEF DESCRIPTION OF DRAWINGS

FIG. 1 is a schematic view illustrating an example of a food drying device.

FIG. 2 is a schematic view illustrating an example of a food drying device to another aspect.

FIG. 3 is a schematic view illustrating an example of a food drying device to another aspect.

FIG. 4 is a schematic view illustrating an example of a food drying device to another aspect.

FIG. 5 is a schematic view illustrating an example of a food drying device to another aspect.

FIG. 6 is a schematic view illustrating an example of a food drying device to another aspect.

FIG. 7 is a schematic view illustrating an example of a food drying device to another aspect.

FIG. 8 is a schematic view illustrating an example of a food drying device to another aspect.

FIG. 9 is a schematic view illustrating an example of a food drying device to another aspect.

FIG. 10 is a schematic view illustrating an example of a food drying device to another aspect.

FIG. 11 is a schematic view illustrating an example of a food drying device to another aspect.

FIG. 12 is a schematic view illustrating an example of a food drying device to another aspect.

FIG. 13 is a schematic view illustrating an example of a food drying device to another aspect.

FIG. 14 is a schematic view illustrating an example of a food drying device to another aspect.

FIG. 15 is a schematic view illustrating an example of a food drying device to another aspect.

FIG. 16 is a schematic view illustrating an example of a food drying device to another aspect.

FIG. 17 is a schematic view illustrating an example of a food drying device to another aspect.

FIG. 18 is a schematic view illustrating an example of a conventional food drying device.

FIG. 19 shows graphs showing a comparison of temporal change of moisture content of a carrot in Experiment 1 of an example.

FIG. 20 shows graphs showing a comparison of temporal change of the relative humidity in a dry warehouse in Experiment 1 in the example.

FIG. 21 shows graphs showing a comparison of the amount of β-carotene in dried kale in Experiment 2 in the example.

FIG. 22 shows graphs showing a comparison of the amount of gross ascorbic acid in the dried kale in Experiment 2 in the example.

FIG. 23 shows graphs showing a comparison of the amount of gross chlorophyll in the dried kale in Experiment 2 in the example.

FIG. 24 shows graphs showing a comparison of superoxide scavenging activities in the dried kale in Experiment 2 in the example.

### DESCRIPTION OF EMBODIMENTS

The present invention will be described in detail below.

A method for drying food according to the present invention is a method for obtaining a dried product of food such as agricultural product and marine product and is characterized in that the food is provided in a dry warehouse for drying the food, upper gas and lower gas in the dry warehouse are circulated by a duct fan provided to the side in the dry warehouse, and the food is dehumidified and dried at the temperature of 60° C. or lower and the relative humidity of 60% or less under the atmospheric pressure.

By drying the food at the normal temperature and under such an atmosphere, it is possible to obtain dry food while preventing loss of original nutrition value of the food, maintaining color, scent, and flavor, and preventing deterioration due to reproduction of bacteria.

Here, food to be dried in the present invention is an agricultural product or a marine product.

Agricultural product in the present invention includes grains, beans, potatoes, vegetables, mountain vegetables, mushrooms, nuts, fruits, and herbs, and marine product includes seaweeds and seafood.

Note that, since an animal product such as meat contains much animal fat and protein and is easily perished during the drying process, a method according to the present invention is not suitable for an animal product.

Food to be dried is commonly washed with water, dirt such as soil and mud attached to the outer surface of the food to be treated is removed, and the food is cut into pieces with appropriate size in advance.

It is preferable that the food be cut into pieces with substantially equal size so that the food is evenly dried. For example, the food is cut into slices or thin pieces with the thickness of 5 mm or less in order to shorten the drying time and to facilitate handling.

Note that, it is preferable that the food to be dried be sterilized and disinfected in advance by a method by which color and flavor are not lost in order to prevent reproduction of bacteria. For example, the food is to be washed with water after it is sterilized by, for instance, being immersed in hypochlorous solution.

Then, the food cut into pieces with appropriate size is dried at the temperature of 60° C. or lower. Note that, in the present invention, drying at the almost constant temperature of 60° C. or lower is referred to as normal temperature drying.

According to the normal temperature drying, it is possible to maintain nutrition value as with freeze dry without deactivating enzymes and the like contained in the food and without expensive equipment and operating cost as required for freeze dry, and it is possible to obtain dry food with color and scent near the original food and condensed flavor without food additives.

Although conventional drying at the high temperature by hot air or the like can shorten drying time as compared with the normal temperature drying, nutrition value is significantly lost due to heat and color, scent, and flavor also tend to be lost as described above. In particular, since enzymes are deactivated if heated up to the temperature over 60° C., it is not possible to obtain powdered food with original excellent characteristic of the food. It is preferable that the drying temperature be 55° C. or lower. In addition, animal food such as seafood is preferably dried at the temperature of 15° C. or lower in order to prevent perishing.

Method of the normal temperature drying is not particularly limited; however, it is preferable to dehumidify and dry the food with the relative humidity of 60% or less while maintaining the temperature as constant as possible in order to efficiently dry the food.

For that purpose, it is preferable to circulate upper gas and lower gas in the dry warehouse by a duct fan provided to the side inside the dry warehouse.

More preferably, the duct fan is provided so that air is taken from the upper part in the dry warehouse and supplied in the horizontal direction at the lower part in the dry warehouse, or so that air is taken from the lower part in the dry warehouse and supplied in the horizontal direction at the upper part of the dry warehouse.

With such a duct fan, it is possible to more effectively control gas circulation in the dry warehouse.

Note that, several duct fans may be provided on the same side for more effective gas circulation in accordance with the volume in the dry warehouse.

In addition, it is preferable that random wind be generated in the horizontal direction in the dry warehouse to make the temperature and the humidity in the horizontal direction in the dry warehouse constant.

Note that, it is preferable that the random wind be generated at constant intervals with a method disclosed in Patent Literature 2. Specifically, it is preferable to install several fans for generating random wind in the horizontal direction in the dry warehouse to the side in the dry warehouse.

In addition, although the amount of moisture (moisture content) in the food after being dried is appropriately determined according to type and form of the food and usage of dry food, it is preferable to dry the food until the moisture content becomes 20% or less, preferably, 5% or less in terms of preservation. The drying time is 10 hours or less, usually, about 2 to 5 hours though it depends on type and form of the food.

In the normal temperature drying, it is preferable that the oxygen concentration in the dry warehouse be 10% or less. Alternatively, gas with the oxygen concentration of 10% or less is supplied in the dry warehouse. More preferably, gas with the humidity lower than outer air is supplied.

Air with the oxygen concentration of 10% or less is normally used as gas to be supplied in the dry warehouse, and air with the humidity lower than outer air is preferable. Accordingly, it is possible to more efficiently dehumidify and dry the food.

It is possible to prevent decrease in substances with anti-oxidation function in the food and prevent decrease in active oxygen removing properties by dehumidifying and drying the food under the atmosphere with the oxygen concentration lower than the atmosphere (oxygen concentration of about 20%). Therefore, oxidation of the dried food is prevented.

Air with the oxygen concentration of 10% or less can be obtained by introducing 1 L of inert gas into 1 L of air (oxygen concentration of about 20%) under the atmospheric pressure, for example.

If it is over 10%, sufficient oxidation prevention effect is not obtained.

The gas is preferably gas in which at least part thereof is substituted by inert gas in terms of oxidation prevention effect.

Specifically, the inert gas is nitrogen, helium, neon, argon, krypton, xenon, or radon, and it is preferable to use nitrogen in terms of cost. More preferably, nitrogen with the purity of 90% or more is used.

By using a method for drying according to the present invention described above, dry food with improved quality as compared with conventional normal temperature dry food can be obtained.

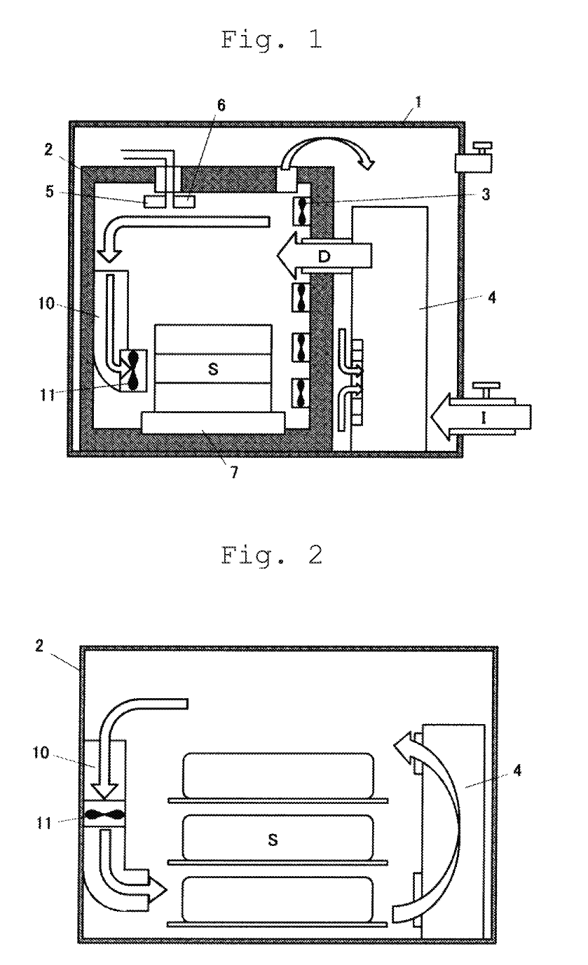

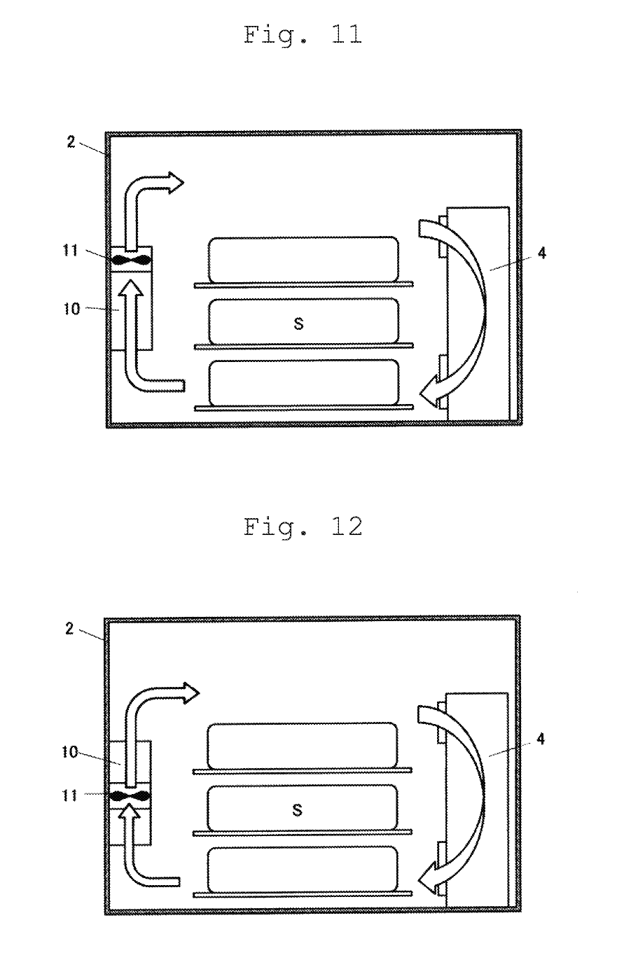

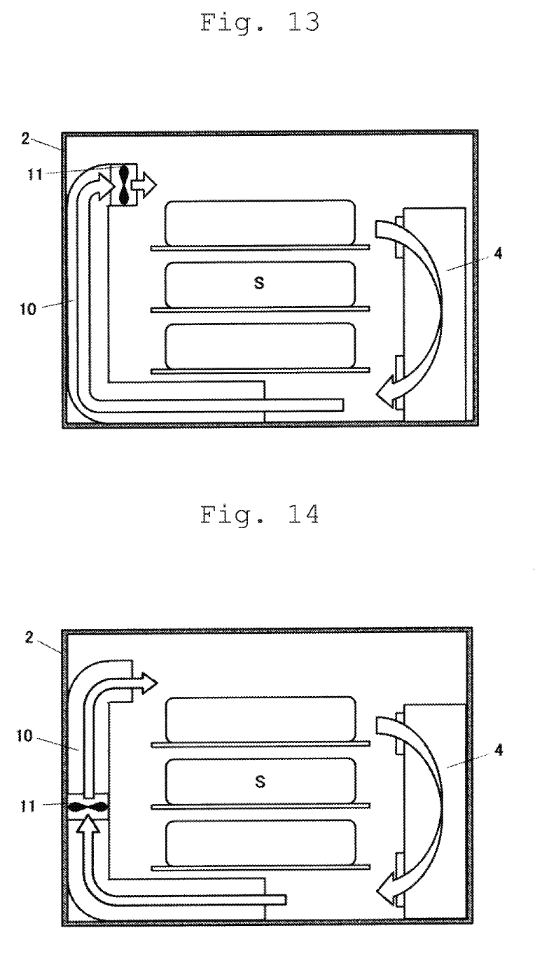

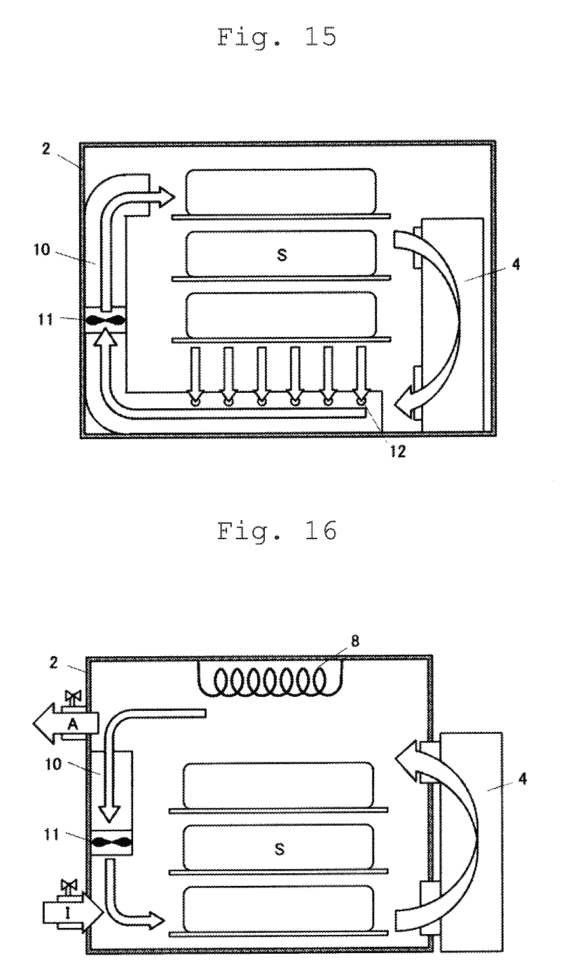

The method for drying according to the present invention as described above can be carried out with a drying device illustrated in FIGS. 1 to 17, for example. Arrows in each figure show flow of gas.

A food drying device illustrated in FIG. 1 includes a dry warehouse 2 with a duct fan 10 and several fans 3 for generating random wind provided to the side inside thereof, and a dehumidifier 4 for supplying dry air (dehumidification gas) D in the dry warehouse 2 and dehumidifying inside the housing 1. A thermo-hygrometer 5, an oxygen concentration meter 6, and a weight scale 7 are provided in the dry warehouse 2 as measurement equipment for measuring the process of drying a sample S.

In such a drying device, after the sample S to be dried is placed on the weight scale 7 provided in the dry warehouse 2, the housing 1 is sealed and inert gas I is introduced so that the oxygen concentration in the device is adjusted.

Note that, the temperature in the dry warehouse 2 may be increased up to 60° C. by providing a heater (not illustrated) in the dry warehouse 2.

In addition, the duct fan 10 in the drying device illustrated in FIG. 1 has an inlet at the upper part of the duct, and has an outlet and a fan 11 for supplying wind in the horizontal direction in the dry warehouse 2 from the lower part of the bent duct.

By circulating gas in the dry warehouse 2 by such a device, supplied gas to contact the entire sample S is uniformed, and it is possible to prevent unevenness of drying depending on the area of placement of the sample S and to shorten drying time.

Note that, any of axial stream fan, cross-flow fan, sirocco fan, and turbo fan can be used as the fan 11 of the duct fan 10.

Moreover, in order to prevent unevenness of drying of the sample S, the sample S may be placed in a float state and the sample S may be rotated to prevent falling.

For comparison, FIG. 18 illustrates an outline of an example of a conventional food drying device.

A drying device illustrated in FIG. 18 supplies dry air (dehumidification gas) D obtained by dehumidifying air A in the dry warehouse 2 by a dehumidifier 4 in a dry warehouse 3 to dehumidify and dry the food. A duct fan 10 provided to the side inside the dry warehouse 2 is straight and has an inlet and a fan 11 at the upper part of the duct.

The conventional duct fan 10 with the fan 11 provided to the inlet side cannot efficiently and evenly circulate gas in the dry warehouse 2 and it is difficult to control the temperature and the humidity at the upper part and the lower part inside the dry warehouse 2 to be even. Therefore, unevenness of drying easily occurs due to area of placement of the sample S and it takes longer time to dry the entire sample S as compared with the device according to the present invention as illustrated in FIG. 1.

Each of FIGS. 2 to 17 illustrates an outline of an example a food drying device according to another aspect.

A drying device illustrated in FIG. 2 has a dehumidifier 4 in a dry warehouse 2, an inlet at the upper part of a duct, a fan 11 at the central part of the duct, and a duct fan 10 with an outlet for supplying air in the horizontal direction in the dry warehouse 2 from the lower part of the bent duct.

By providing the fan 11 in the duct fan 10 at the central part of the duct as described or at the outlet as illustrated in FIG. 1, it is possible to easily control circulation of gas in the dry warehouse 2 and to more efficiently dry the food as compared with the conventional device illustrated in FIG. 18 in which the fan is provided to the inlet.

In addition, in such a drying device, it is possible to dehumidify inside the dry warehouse 2 by the dehumidifier 4 and to use the exhaust heat to increase the temperature of gas in the dry warehouse 2.

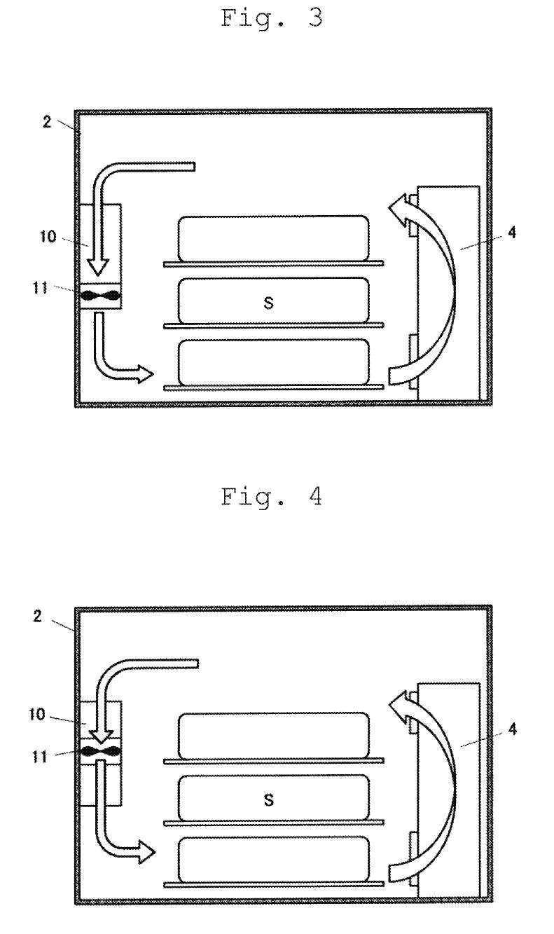

The outlet of the duct of the duct fan 10 in FIG. 1 is not bent and straight in a drying device illustrated in FIG. 3. Also with such an outlet, it is possible to supply air in the horizontal direction at the lower part inside the dry warehouse 2 along the side and the bottom inside the dry warehouse 2.

Similarly, the fan 11 of the duct fan 10 may be provided to the central part of the duct as in a drying device illustrated in FIG. 4.

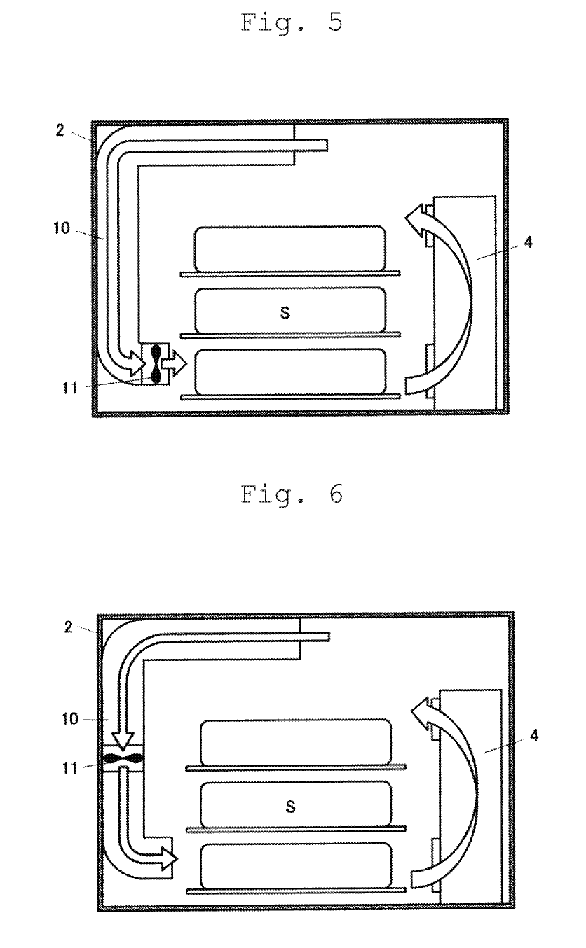

In a drying device illustrated in FIG. 5, the duct of the duct fan 10 in FIG. 1 extends along the side and the ceiling and is bent, and the inlet of the duct is provided to the ceiling in the dry warehouse 2 above the sample S.

It is possible to easily guide the gas supplied from the dehumidifier 4 to the inside of the duct fan 10 to efficiently dry the food with the duct fan 10 having such a structure when the size of the dry warehouse 2 is large.

Similarly, the fan 11 of the duct fan 10 may be provided to the central part of the duct as in a drying device illustrated in FIG. 6.

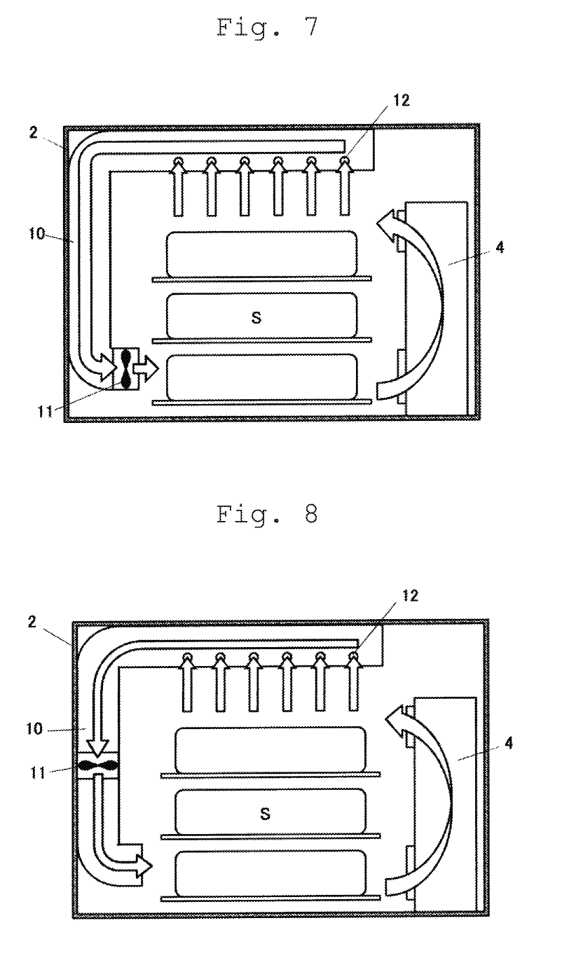

For a drying device illustrated in FIG. 7, several holes 12 are made in the duct at the ceiling of the duct fan 10 in FIG. 5. With such a structure, it is possible to prevent retention of water vapor from the sample S above the sample S.

Similarly, the fan 11 of the duct fan 10 may be provided to the central part of the duct as in a drying device illustrated in FIG. 8.

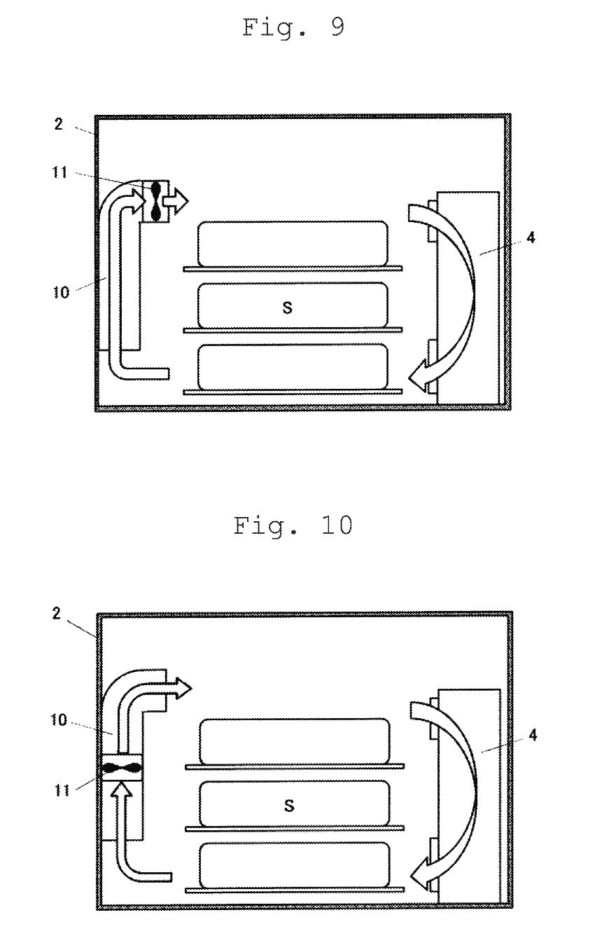

A drying device in each of FIGS. 9 to 15 has a structure in which the duct fan 10 is provided so that the flow of gas is opposite to that in the drying device in FIGS. 1 to 6 and 8 and gas flow of the dehumidifier 4 is also opposite. Even if the direction of gas flow is opposite in the dry warehouse 2, it is possible to efficiently dry the sample S as long as the structure allows circulation without unevenness so that the temperature and the humidity are even at the upper and the lower parts in the dry warehouse 2.

A drying device illustrated in FIG. 16 has a structure in which the dehumidifier 4 in FIG. 3 is provided outside the dry warehouse 2, and other structures are the same as those of the drying device illustrated in FIG. 3.

Since exhaust heat of the dehumidifier 4 can be discharged to the atmosphere outside the dry warehouse 2 in such a drying device, it is possible to easily adjust and manage the temperature as the temperature of gas in the dry warehouse 2 is raised only by the heater 8.

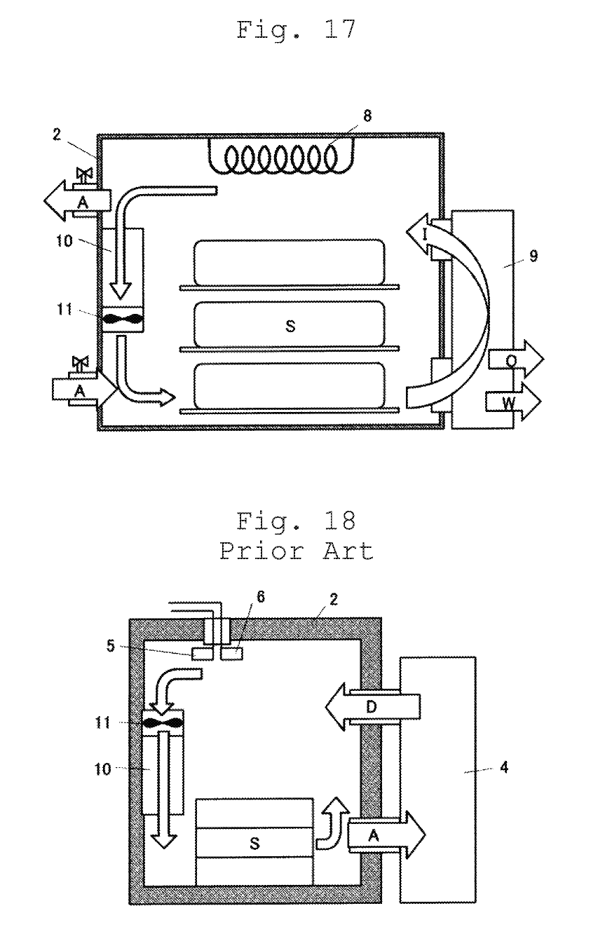

A drying device illustrated in FIG. 17 has a structure in which the dehumidifier 4 in FIG. 16 is substituted by a nitrogen generator 9, and other structures are the same as those of the drying device illustrated in FIG. 17.

In such a drying device, air in the dry warehouse 2 is separated into moisture W, oxygen O, and inert gas (nitrogen) I by the nitrogen generator 10 when gas (air) A is introduced in the dry warehouse 2. Then, the moisture W and the oxygen O are discharged to the atmosphere outside the dry warehouse 2, and it is possible to supply only the inert gas (nitrogen) I to the dry warehouse 2 from the nitrogen generator 9.

Note that, a known nitrogen generator such as membrane separation type or PSA (Pressure Swing Absorption) type can be used as the nitrogen generator 10.

### EXAMPLES

Hereinafter, the present invention will be more specifically described based on examples; however, the present invention is not limited to the examples described below.

### (Experiment 1) Comparison of Drying Efficiency Depending on Whether Dehumidification is Performed or not

### Example 1

1 Kg of carrot in pieces of 5 mm is dried and dehumidified at the temperature of 40° C. by the food drying device illustrated in FIG. 1.

### Comparison Example 1

In Example 1, 1 Kg of carrot in pieces of 5 mm is dried at the temperature of 40° C. without dehumidification by supplying and discharging outside air at all times.

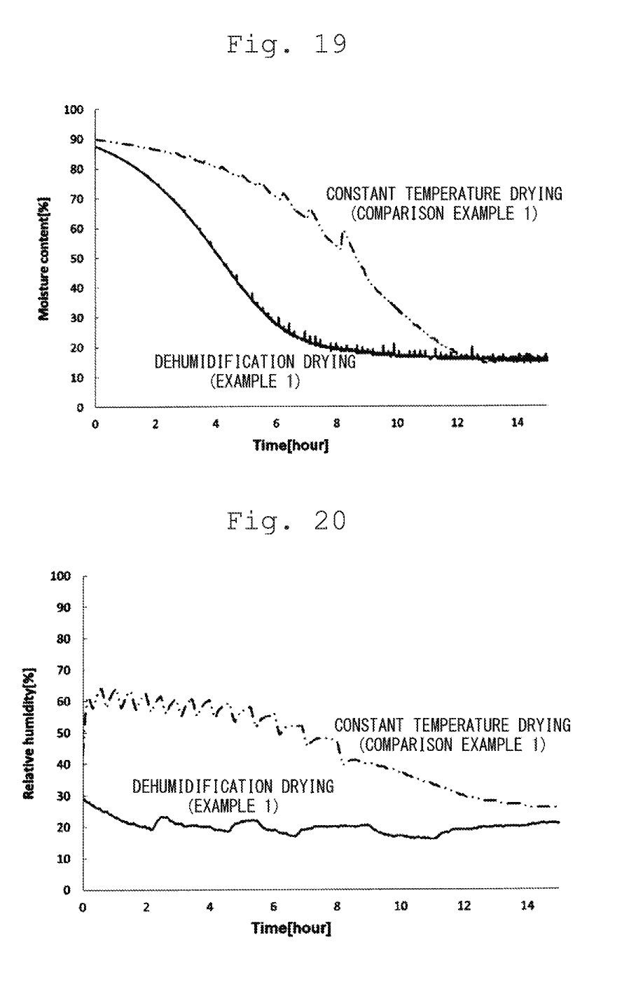

Graphs by which Example 1 is compared with Comparison Example 1 with respect to the moisture content of the carrot and the temporal change of the relative humidity in the dry warehouse are shown in FIGS. 19 and 20.

As shown by the graphs in FIG. 19, the moisture content of the carrot became a constant value after decreasing to 16% after about 8 hours in the case of dehumidification drying (Example 1). In contrast, the moisture content of the carrot became a constant value after decreasing to 16% after about 13 hours in the case of the conventional normal temperature (constant temperature) drying without dehumidification (Comparison Example 1).

As shown, it was possible to dry earlier by about 40% in the case with dehumidification than the case without dehumidification.

In addition, as shown by the graphs of FIG. 20, while the relative humidity in the dry warehouse in the case of dehumidification drying (Example 1) ranged between about 20 to 25% after drying was started, the relative humidity in the dry warehouse in the case of the conventional normal temperature (constant temperature) drying without dehumidification (Comparison Example 1) became 60% immediately after drying was started and became a constant value of 30% after about 13 hours.

### (Experiment 2) Comparison of Ingredient Variation of Dry Food

### [Examples 2 and 3] (Low-Oxygen Atmosphere)

A kale was used as a sample, its stem was removed as a pre-treatment, it was cut into size of 20 mm×20 mm, immersed in hypochlorous solution for 10 minutes for sterilization and disinfection, washed with tap water thereafter, and adhered moisture was removed by wiping.

This kale was dried by the food drying device illustrated in FIG. 1. In the dry warehouse 2, dry air (dehumidification gas) D from the dehumidifier 4 was supplied, gas in the dry warehouse 2 was circulated by the duct fan 10, and random wind was generated in the horizontal direction by the several fans 3.

500 g of cut kale was put into three mesh trays (mesh 5 mm×5 mm) with 200 mm×200 mm×height 50 mm in equal amounts, and the mesh trays were placed over one another on the weight scale 7 provided in the dry warehouse 2.

Then, the housing 1 was sealed, and nitrogen gas was introduced as the inert gas I to adjust the concentration of oxygen inside.

Drying was performed at the temperature of 55° C. with the oxygen concentration in the dry warehouse 2 set to 0% (Example 2) and 10% (Example 3) for 20 hours under normal pressure.

### [Comparison Example 2] (Under Atmosphere)

Drying was performed with the oxygen concentration of 20.9% (under atmosphere) in Example 2 with other conditions the same as those of Example 3.

### [Comparison Example 3] (Freeze Dry)

450 g of kale cut in the same manner as Example 2 was divided onto three aluminum foil trays with a size of 220 mm×220 mm, each tray having 150 g, and put into freeze dry equipment in a stacked state.

After preliminary freezing at the temperature of −40° C. for 20 hours and intake process for 20 minutes, the pressure was decreased to about 2 Pa. Thereafter, after primary drying was performed at the temperature of −10° C. for 12 hours, secondary drying was performed at the temperature of 20° C. for 12 hours.

With respect to the kale that was dried so that the moisture content thereof became about 5% in Examples 2 and 3 and Comparison Examples 2 and 3, ingredients of β-carotene, gross ascorbic acid, gross chlorophyll, and superoxide scavenging activities were analyzed. β-carotene and gross ascorbic acid were measured by high-performance liquid chromatography, chlorophyll was measured by absorptiometric method, and superoxide scavenging activities were measured by electron spin resonance method.

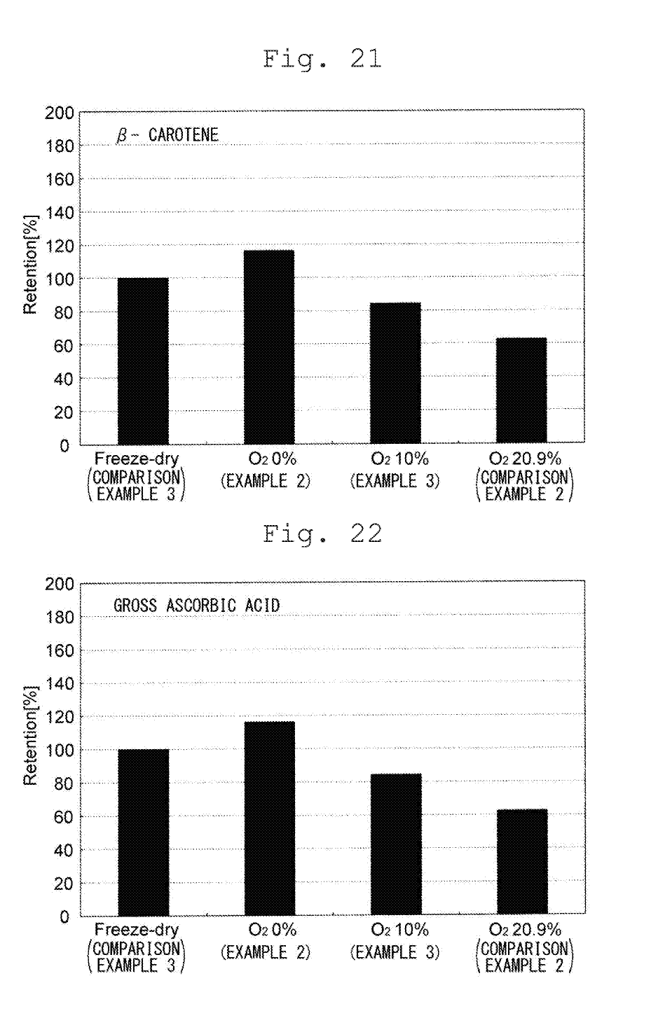

Graphs that compare these analysis results are shown in FIGS. 21 to 24.

Here, β-carotene has strong anti-oxidation function, and is transformed to vitamin A in a body. Gross ascorbic acid is referred to as vitamin C, has anti-oxidation function, and is often used as an indication of quality of processed food since it is vulnerable to heating and oxidation. Gross chlorophyll is also referred to as chlorophyll, and green color of vegetables is due to its ingredient. Superoxide scavenging activities are a barometer for how much active oxygen, which is a cause of aging when existing in a body in excess, can be removed.

There was no significant difference during drying process (change of moisture content) due to difference in oxygen concentration in Example 2 and 3 and Comparison Example 2 and 3 described above.

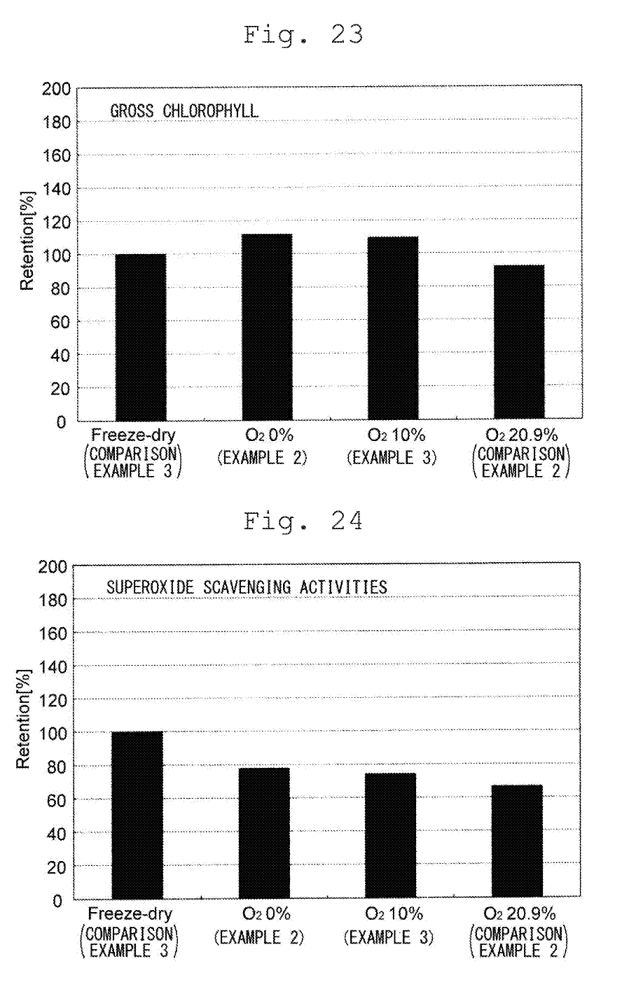

With respect to ingredient analysis of dried kale of β-carotene (see FIG. 21), although there was no significant difference due to oxygen concentration, the amount decreased was less as compared with freeze dry (Comparison Example 3). The amount of decrease in gross ascorbic acid (see FIG. 22) became less as the oxygen concentration was lower, and was less as compared with freeze dry (Comparison Example 3). The amount of decrease in gross chlorophyll (see FIG. 23) was also less as compared with freeze dry (Comparison Example 3) and the case of under atmosphere (Comparison Example 2) though difference due to drying condition was smaller than gross ascorbic acid. In addition, when drying under the low-oxygen atmosphere (Examples 2 and 3), the amount of decrease in superoxide scavenging activities (see FIG. 24) was reduced as compared with the case of under atmosphere (Comparison Example 2) though the amount of decrease was not much less than freeze dry (Comparison Example 3).

From the analysis results described above, it was recognized that it is possible to effectively prevent decrease in gross ascorbic acid in food and reduction in active oxygen removal properties by dehumidification drying at the normal temperature with a process simpler than freeze dry.

### (Experiment 3) Comparison of Yield of Dry Food

### [Comparison Example 4] (Conventional Drying Device)

With a conventional drying device as illustrated in FIG. 18, kale as a sample S was prepared and dried in the same way as Example 2.

In a dry warehouse 2, dry air (dehumidification gas) D was supplied from a dehumidifier 4, the gas in the dry warehouse 2 was circulated by a duct fan 10 having a fan 11 to the inlet side, and kale was dried at the temperature of 55° C. and under the normal pressure for 20 hours.

In Example 2 described above, the pieces of the kale placed at any locations were dried without unevenness and the yield of drying was 99%. In contrast, in Comparison Example 4 described above, the pieces of the kale placed near the center were not sufficiently dried by the conventional drying device, and there was unevenness in drying depending on the locations. The yield of drying was only 85%.

### REFERENCE SIGNS LIST

1 Housing
2 Dry Warehouse
3, 11 Fan
4 Dehumidifier
5 Thermo-Hygrometer
6 Oxygen Concentration Meter
7 Weight Scale
8 Heater
9 Nitrogen Generator
10 Duct Fan
12 Hole
A Gas (Air)
D Dry Air (Dehumidification Gas)
I Inert Gas (Nitrogen)
S Sample
W Moisture
O Oxygen

1-12. (canceled)

13. A food drying device for containing and drying food of an agricultural product or a marine product in a dry warehouse, wherein
a dehumidifier for dehumidifying gas in the dry warehouse is provided inside the dry warehouse or outside the dry warehouse, and a duct fan is provided to a side inside the dry warehouse,
the duct fan has a duct provided to one side inside the dry warehouse, an inlet provided at an upper part of the duct, an outlet for supplying air in a horizontal direction in the dry warehouse provided at a lower part of the duct, and a fan provided at the central part or the outlet of the duct, and air is taken at the upper part in the dry warehouse and supplied in the horizontal direction at the lower part in the dry warehouse by the duct fan, and
the dry warehouse is set to under atmospheric pressure, and at a temperature of 60° C. or lower and a relative humidity of 60% or less.

14. A food drying device for containing and drying food of an agricultural product or a marine product in a dry warehouse, wherein
a dehumidifier for dehumidifying gas in the dry warehouse is provided inside the dry warehouse or outside the dry warehouse, and a duct fan is provided to a side inside the dry warehouse,
the duct fan has a duct provided to one side inside the dry warehouse, an inlet provided at a lower part of the duct, an outlet for supplying air in a horizontal direction in the dry warehouse provided at an upper part of the duct, and a fan provided at the central part or the outlet of the duct, and air is taken at the lower part in the dry warehouse and supplied in the horizontal direction at the upper part in the dry warehouse by the duct fan, and
the dry warehouse is set to under atmospheric pressure, and at a temperature of 60° C. or lower and a relative humidity of 60% or less.

15. The food drying device according to claim 13, wherein several fans for generating random wind in the horizontal direction in the dry warehouse are provided to another side inside the dry warehouse.

16. The food drying device according to claim 13, wherein a nitrogen generation unit for generating nitrogen with a purity of 90% or more to be supplied in the dry warehouse is provided outside the dry warehouse.

17. A method for drying food with the food drying device according to claim 13, wherein
air is taken at the upper part in the dry warehouse by the duct fan and supplied in the horizontal direction at the lower part in the dry warehouse, and
the food is dehumidified and dried under atmospheric pressure and at the temperature of 60° C. or lower and the relative humidity of 60% or less.

18. A method for drying food with the food drying device according to claim 14, wherein
air is taken at the lower part in the dry warehouse by the duct fan and supplied in the horizontal direction at the upper part in the dry warehouse, and
the food is dehumidified and dried under atmospheric pressure and at the temperature of 60° C. or lower and the relative humidity of 60% or less.

19. The method for drying food according to claim 17, wherein the food is dehumidified and dried while random wind is generated in the horizontal direction in the dry warehouse.

20. The method for drying food according to claim 17, wherein the food is dehumidified and dried while an oxygen concentration in the dry warehouse is set to 10% or less.

21. The method for drying food according to claim 17, wherein the food is dehumidified and dried while gas with an oxygen concentration of 10% or less is supplied in the dry warehouse.

22. The method for drying food according to claim 17, wherein the food is dehumidified and dried while gas with a humidity lower than outer air is supplied in the dry warehouse.

23. The method for drying food according to claim 17, wherein the food is dehumidified and dried while air with an oxygen concentration of 10% or less substituted by nitrogen with a purity of 90% or more is supplied in the dry warehouse.

24. The method for drying food according to claim 17, wherein the food is dehumidified and dried while nitrogen gas with a purity of 90% or more and with a humidity lower than outer air is supplied in the dry warehouse.

25. Food produced by the method for drying food according to claim 17.
